(19) United States
(12) Patent Application Publication
(10) Pub. No.: US 2020/0108419 A1
(43) Pub. Date: Apr. 9, 2020

(54) Maintenance device for Huanghuali bracelets

(71) Applicant: Caiqiao Chen, Foshan City (CN)

(72) Inventor: Caiqiao Chen, Foshan City (CN)

(21) Appl. No.: 16/709,859

(22) Filed: Dec. 10, 2019

(30) Foreign Application Priority Data
Aug. 27, 2019 (CN) 201910798015X

(51) Int. Cl. B08B 1/00; B24B 29/04; B08B 1/02

(52) U.S. Cl. CPC B08B 1/001; B24B 29/04; A44C 5/00; B08B 1/02; B08B 1/008

(57) ABSTRACT

The invention discloses a maintenance device for a yellow flower pear bracelet string, which includes a bottom plate. A power mechanism is provided on a front surface of the bottom plate, and the power mechanism includes a motor installed on the front surface of the bottom plate. The motor serves as a power source. Can drive the entire device to run, a rope is provided on the front side of the bottom plate, eighteen yellow pear beads are stringed on the rope, a maintenance mechanism is provided on the upper side of the power mechanism, and the maintenance mechanism includes a top that can be moved forward and backward The cloth piece and the bottom piece. According to the shape of the Huanghuali bracelet and the maintenance requirements of the Huanghuali wooden bracelet, this device can automatically clean and polish the yellowhuali wooden beads in the Huanghuali bracelet in order, with good maintenance effect, and the device has a high degree of automation, which is very time-saving, and it is not easy to cause damage to the Huanghuali bracelets by using the mechanical maintenance method, which ensures the quality of the Huanghuali bracelets.

### CROSS-REFERENCES TO RELATED APPLICATIONS

The present application claims priority from Chinese application No. 201910798015X filed on Aug. 27, 2019 which is hereby incorporated by reference in its entirety.

### TECHNICAL FIELD

The field of jewelry maintenance according to the present invention is specifically a maintenance device for Huanghuali bracelets.

### BACKGROUND OF THE INVENTION

Huanghuali wood has a scientific name of fragrant rosewood. Because of its unique fragrance and elegant pattern, it is often made into bracelets and is very popular. Huanghuali bracelets need regular maintenance to maintain their beautiful appearance. Most of the maintenance methods of Huanghuali bracelets are mechanical kneading, which takes a lot of time. If you use chemical methods for maintenance, you can't guarantee that the quality of Huanghuali bracelets will not be affected.

### BRIEF SUMMARY OF THE INVENTION

The technical problem to be solved by the present invention is to provide a maintenance device for Huanghuali bracelets, which overcomes the time-consuming maintenance of Huanghuali bracelets, and the problem of affecting the quality of chemically maintaining Huanghuali bracelets is overcome.

The present invention is achieved by the following technical solutions.

A maintenance device for a Huanghuali bracelet string according to the present invention includes a bottom plate, and a power mechanism is provided on the front surface of the bottom plate. The power mechanism includes a motor installed on the front surface of the bottom plate. The motor can be used as a power source. Drive the entire device to run;

A rope is provided on the front side of the bottom plate, and eighteen Huanghuali wooden beads are stringed on the rope. A maintenance mechanism is provided on the upper side of the power mechanism. The maintenance mechanism includes a top cloth sheet and a bottom cloth sheet that can be moved forward and backward. When the top cloth piece moves forward, the bottom cloth piece moves backward, thereby cleaning and polishing the yellow rosewood beads between the top cloth piece and the bottom cloth piece;

A replacement mechanism is provided on the left side of the power mechanism. The replacement mechanism includes a rotatable rotating rod. A pressure chamber with a downward opening is arranged in the lower end surface of the rotary rod. A thrust block is fixed at the lower end of the pressure spring, the compression spring is in a compressed state, a clamping block and a clamping plate are provided on the left side of the rotating rod, and a transmission block is fixed on the right end face of the clamping block, and the thrust block moves to At the clamp block, the pressure spring can be reset to push the clamp block to move to the left, so that the clamp plate and the clamp block clamp one of the Huanghuali wood beads, and the thrust block then pushes the driving block rises, thereby driving all the Huanghuali wooden beads together with the rope to rotate clockwise, so that the next Huanghuali wooden beads moves between the top cloth piece and the bottom cloth piece.

Preferably, the power mechanism further includes a driving shaft rotatably disposed on the front end surface of the motor, a driving gear is fixed on the driving shaft, and a transmission is rotatably connected to the front end surface of the bottom plate on the upper side of the motor. A transmission shaft and a transmission gear are fixed on the transmission shaft, the transmission gear meshes with the driving gear, and an output shaft rotatably connected to the front end surface of the bottom plate is arranged on the upper side of the transmission shaft. A drive bevel gear and an output pulley are fixed on the output shaft. The drive bevel gear is located on the front side of the output pulley, and the output pulley and the drive pulley are frictionally driven by a belt.

Preferably, the maintenance mechanism further includes a support block fixedly connected to the front end surface of the bottom plate, a right end surface of the support block is rotatably provided with a transverse axis, and a semicircular gear is fixed on the transverse axis. An output bevel gear is fixed at the right end of the shaft. The output bevel gear meshes with the transmission bevel gear. The bottom plate is provided with a receiving cavity. A central axis is provided between the left and right end walls of the receiving cavity. A central gear is fixedly arranged on the upper side of the central gear, and a top rod that can be slid back and forth is engaged with the central gear. The front end of the top rod is located in the external space, and the top cloth sheet is fixed at On the lower end surface of the bottom arc block, a bottom spring fixedly connected to the rear end wall of the storage cavity is fixed at the rear end of the top rod, and a movement rod that can slide back and forth is provided under the central gear. The moving rod is meshed with the central gear, the bottom cloth piece is fixedly disposed on the upper end surface of the moving rod, and a rack is embedded in the lower end surface of the moving rod in the external space.

Preferably, the replacement mechanism further includes a torsion shaft rotatably connected to the front surface of the bottom plate, a force spring is provided between the torsion shaft and the bottom plate, and an output gear and a tilt are fixed on the torsion shaft. The tilting rod is located on the front side of the output gear, a moving block is provided on the lower side of the tilting rod, and an expansion groove with an opening facing upward is provided in the upper end surface of the moving block; Sliding in the groove, a lower end of the tilting rod is fixedly provided with a telescopic spring whose lower end is fixedly connected to the lower end wall of the telescopic groove, a lower end of the moving block is fixedly provided with an inclined plate, and the rotating rod is fixed on the lower end of the inclined plate A first positioning rod is fixedly provided on the front surface of the bottom plate, and an inclined block is provided on the first positioning rod through a first torsion spring, and an upper side of the inclined plate is fixed to the front surface of the bottom plate A connected arc surface block, a second positioning rod fixedly connected to the front surface of the bottom plate is provided on the upper side of the arc surface block, and a transmission rod is provided on the second positioning rod through a second torsion spring. The upper side of the transmission rod is provided with the bottom plate Fixing the top end face of arcuate blocks connected to the transmission lever is provided with a curved bottom side of the block and the front end face of the bottom plate is fixedly connected.

Preferably, a moving groove with an opening facing forward is provided in the front end surface of the bottom plate, a moving spring is fixed at the lower end wall of the moving groove, and a moving block slidingly connected to the moving groove is fixed at the upper end of the moving spring. The front end of the moving block is fixedly provided with the splint, and the right end face of the splint is fixedly provided with a support plate. The support plate is provided with a lateral slot opening to the right, and a lateral spring is fixed at the left end wall of the lateral slot. The right end of the lateral spring is fixedly provided with a moving plate slidably connected to the lateral groove, and the clamping block is fixed at the right end of the moving plate.

Preferably, after the driving gear rotates, it can mesh with the output gear.

Preferably, the compression spring is in a compressed state.

Preferably, the semicircular gear can be engaged with the rack after rotating.

Preferably, a support rod is fixed on the front surface of the bottom plate, and the support rod is used to support the Huanghuali wood beads.

Beneficial effect of the present invention: The device can automatically clean and polish the yellow flower pear wooden beads in a sequence according to the shape of the yellow flower pear bracelet string and the maintenance requirements of the yellow flower pear bracelet, and the maintenance effect is good, and The device has a high degree of automation and is very time-saving. The mechanical maintenance method is not easy to cause damage to the yellow flower pear bracelet, which ensures the quality of the yellow flower pear bracelet.

### BRIEF DESCRIPTION OF THE DRAWINGS

In order to more clearly illustrate the embodiments of the invention or the technical solutions in the prior art, the drawings used in the description of the embodiments or the prior art will be briefly introduced below. Obviously, the drawings in the following description are merely For some embodiments of the invention, for those skilled in the art, other drawings can be obtained based on these drawings without paying creative labor.

FIG. 1 is a schematic front structural view of a whole section of a maintenance device for a Huanghuali bracelet string of the present invention;

FIG. 2 is an enlarged schematic view of A in FIG. 1;

FIG. 3 is an enlarged schematic view at a position B in FIG. 1;

FIG. 4 is a schematic diagram in the direction of C-C in FIG. 1;

FIG. 5 is a schematic diagram of the D-D direction in FIG. 2;

FIG. 6 is a schematic diagram of the direction E-E in FIG. 3.

### DETAILED DESCRIPTION OF THE INVENTION

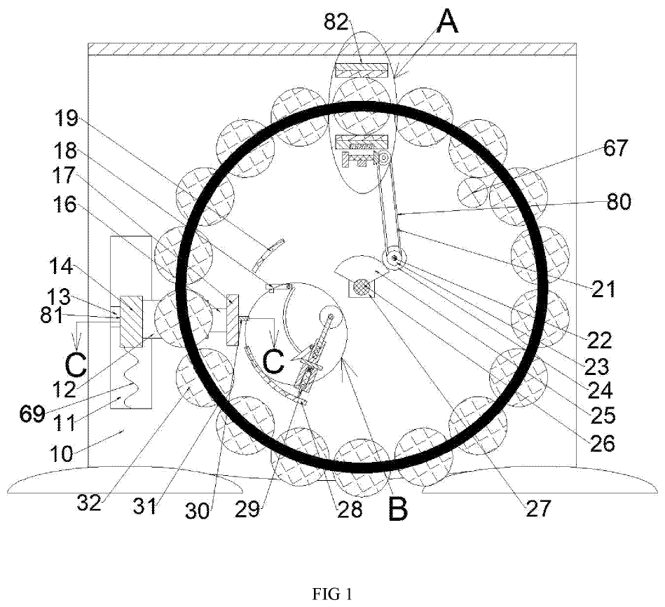

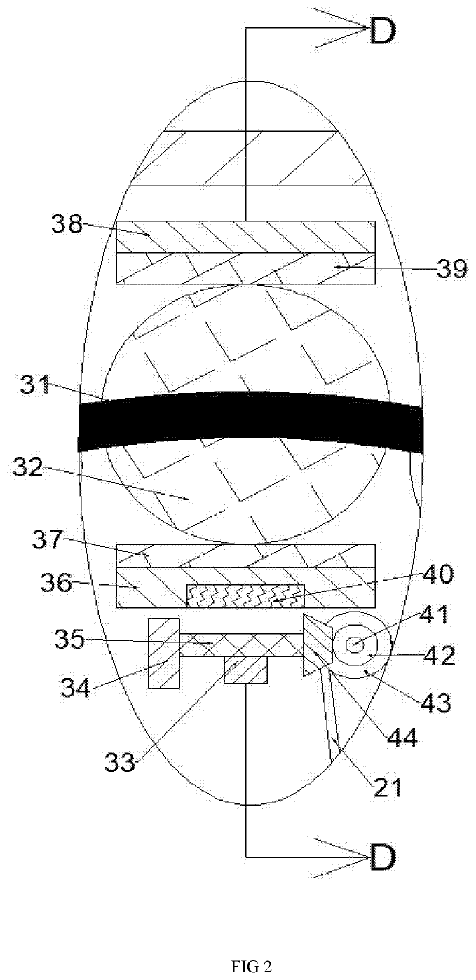

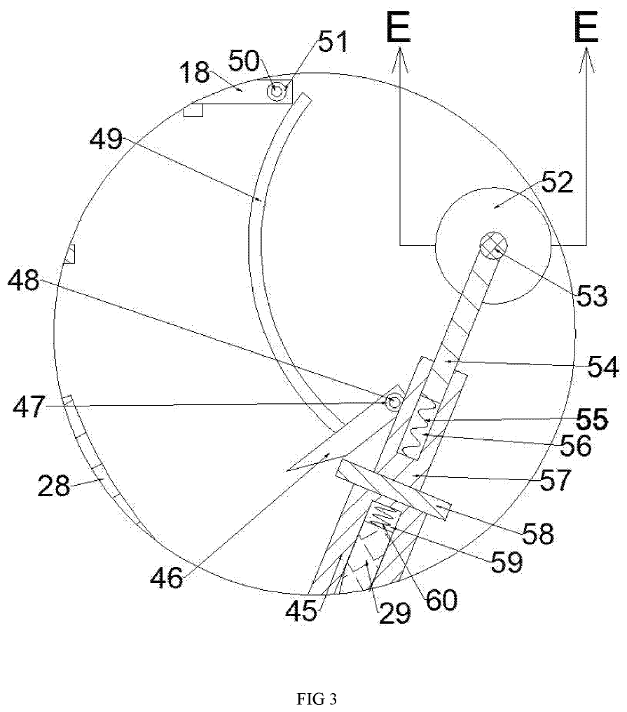

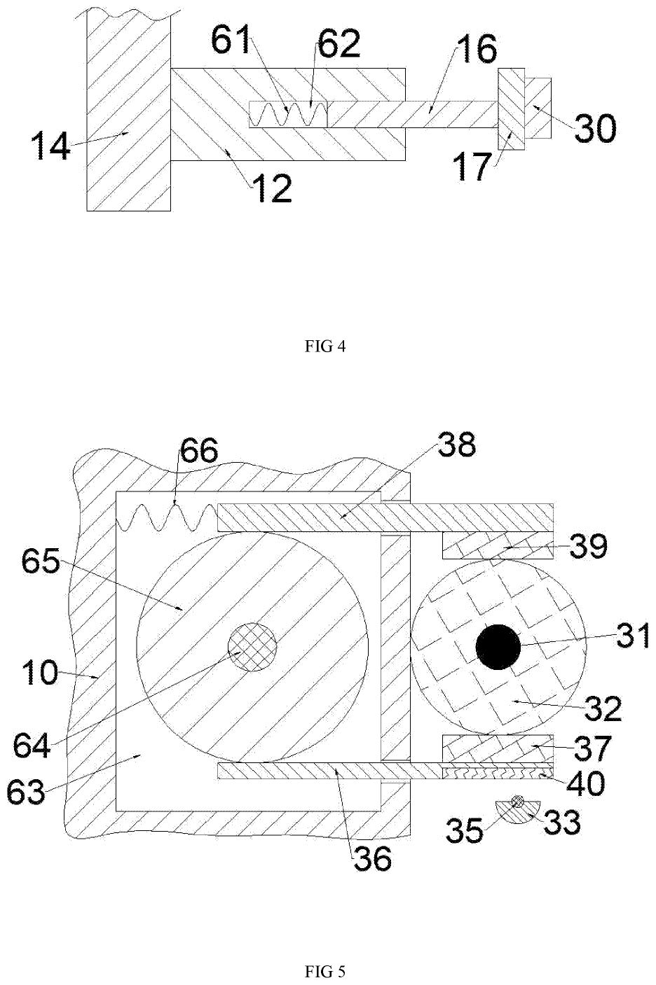

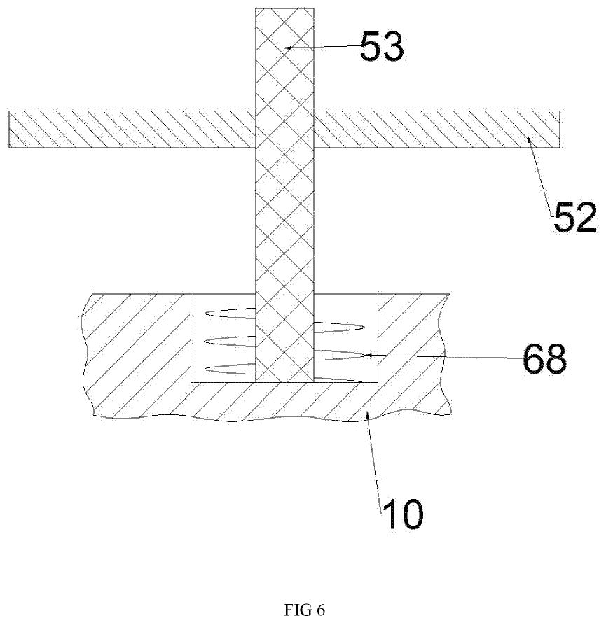

The present invention is described in detail below with reference to FIGS. 1-6. For convenience of description, the orientation described below is defined as follows: the up-down, left-right, front-back direction described below is consistent with the up-down, left-right, front-back direction of the projection relationship of FIG. 1 itself.

A schematic diagram of the mechanical mechanism of a maintenance device for a Huanghuali bracelet string as described in conjunction with FIGS. 1-6 includes a bottom plate 10, and a power mechanism 80 is provided on the front surface of the bottom plate 10, and the power mechanism 80 includes A motor 27 at the front end surface of the bottom plate 10, which serves as a power source to drive the entire device to operate;

A rope 31 is provided on the front side of the bottom plate 10, and eighteen yellow rosewood beads 32 are strung on the rope 31. A maintenance mechanism 82 is provided on the upper side of the power mechanism 80, and the maintenance mechanism 82 includes forward and backward movement. The top cloth sheet 39 and the bottom cloth sheet 37, when the top cloth sheet 39 moves forward, the bottom cloth sheet 37 moves backward, so that between the top cloth sheet 39 and the bottom cloth sheet 37 Huanghuali wooden beads 32 for cleaning and polishing;

A replacement mechanism 81 is provided on the left side of the power mechanism 80. The replacement mechanism 81 includes a rotatable rotating lever 45. A pressure chamber 59 having a downward opening is provided in the lower end surface of the rotating lever 45. A pressure spring 60 is fixed on the end surface, and a thrust block 29 is fixed on the lower end of the pressure spring 60. The pressure spring 60 is in a compressed state. A clamping block 17 and a clamping plate 14 are provided on the left side of the rotating rod 45. A transmission block 30 is fixed on the right end face, the thrust block 29 moves to the clamp block 17, and the pressure spring 60 can be reset to push the clamp block 17 to the left, so that the clamp plate 14 and the clamping block 17 clamps one of the Huanghuali wooden beads 32, and the thrust block 29 then pushes the transmission block 30 to rise, thereby driving all the Huanghuali wooden beads 32 together with the rope 31 to rotate clockwise, so that The next Huanghuali wooden beads 32 moves between the top cloth piece 39 and the bottom cloth piece 37.

Advantageously, the power mechanism 80 further includes a driving shaft 26 rotatably disposed on a front surface of the motor 27. A driving gear 25 is fixed on the driving shaft 26, and an upper side of the motor 27 is provided with the bottom plate. 10 The front end surface of the transmission shaft 22 is rotationally connected. The transmission shaft 22 is fixedly provided with a transmission pulley 23 and a transmission gear 24. The transmission gear 24 meshes with the driving gear 25. An upper side of the transmission shaft 22 is provided with An output shaft 41 is rotatably connected to the front surface of the bottom plate 10, and a transmission bevel gear 42 and an output pulley 43 are fixed on the output shaft 41. The transmission bevel gear 42 is located on the front side of the output pulley 43. The output pulley 43 and the transmission pulley 23 are frictionally transmitted through a belt 21.

Advantageously, the maintenance mechanism 82 further includes a support block 34 fixedly connected to the front end surface of the bottom plate 10. A right end surface of the support block 34 is rotatably provided with a transverse shaft 35, and a semicircle is fixed on the transverse shaft 35. An output bevel gear 44 is fixed to the right end of the horizontal shaft 35. The output bevel gear 44 meshes with the transmission bevel gear 42. The bottom plate 10 is provided with a storage cavity 63, and the storage cavity 63 A central shaft 64 is rotatably provided between the left and right end walls, and a central gear 65 is fixedly fixed on the central shaft 64. A top bar 38 that can be slid back and forth is provided on the upper side of the center gear 65. The gear 65 meshes, the front end of the top rod 38 is located in the outer space, the top cloth piece 39 is fixed on the lower end surface of the bottom arc block 28, and the rear end of the top rod 38 is fixedly provided with the storage cavity 63 The rear end wall is fixedly connected with a bottom spring 66, a lower side of the sun gear 65 is provided with a movable lever 36 that can slide forward and backward, the movable lever 36 is engaged with the central gear 65, and the bottom cloth sheet 37 is fixedly disposed at The upper end face of the moving rod 36, and the lower side of the moving rod 36 in the outer space Surface embedded with a rack 40.

Advantageously, the replacement mechanism 81 further includes a torsion shaft 53 rotatably connected to the front surface of the bottom plate 10. A torsion shaft 68 is disposed between the torsion shaft 53 and the bottom plate 10. An output gear 52 and a tilt lever 54 are fixedly arranged. The tilt lever 54 is located on the front side of the output gear 52. A movement block 57 is provided on the lower side of the tilt lever 54. On the upper telescopic groove 56, the inclined rod 54 can slide in the telescopic groove 56, and the lower end of the inclined rod 54 is fixedly provided with a telescopic spring 55 whose lower end is fixedly connected to the lower end wall of the telescopic groove 56. A lower plate 57 is fixedly provided with an inclined plate 58, the rotating rod 45 is fixed on the lower surface of the inclined plate 58, and a first positioning rod 48 is fixed on the front surface of the bottom plate 10. The first torsion spring 47 is rotatably provided with an inclined surface block 46. An upper surface of the inclined surface block 46 is provided with an arc surface block 49 fixedly connected to the front end surface of the bottom plate 10. The second positioning rod 50 fixedly connected to the front surface of the bottom plate 10 is connected to the second positioning rod 50 through a second twist. 51 rotation is provided with a transmission rod 18, an upper side of the transmission rod 18 is provided with a top arc block 19 fixedly connected to the front surface of the bottom plate 10, and a lower side of the transmission rod 18 is provided with the front end of the bottom plate 10 The bottom arc-shaped block 28 of which the surface is fixedly connected;

A moving slot 11 with an opening facing forward is provided in the front end surface of the bottom plate 10. A moving spring 69 is fixed at the lower end wall of the moving slot 11. An upper end of the moving spring 69 is fixed with a sliding connection with the moving slot 11. The moving block 13 is fixedly provided with the clamping plate 14 at the front end thereof, a right end surface of the clamping plate 14 is fixedly provided with a support plate 12, and the support plate 12 is provided with a lateral groove 62 opening to the right. A lateral spring 61 is fixed on the left end wall of the groove 62, and a moving plate 16 slidingly connected to the lateral groove 62 is fixed on the right end of the lateral spring 61. The clamping block 17 is fixed on the right end of the moving plate 16.

Beneficially, the driving gear 25 can mesh with the output gear 52 after rotating.

Advantageously, the compression spring 60 is in a compressed state.

Beneficially, the semi-circular gear 33 can mesh with the rack 40 after rotating.

Beneficially, a support rod 67 is fixed on the front surface of the bottom plate 10, and the support rod 67 is used to support the yellow pear wood beads 32.

The sequence of mechanical actions of the entire device:

(1) Hang the Huanghuali wooden beads 32 and the rope 31 as shown in FIG. 1, start the motor 27 and drive the driving shaft 26 to rotate, the driving shaft 26 drives the driving gear 25 to rotate, and the driving gear 25 and the transmission gear 24 mesh with each other The driving gear 24 is driven to rotate the driving pulley 23 to rotate with the driving gear 24. Through the friction transmission of the belt 21, the driving pulley 23 drives the output pulley 43 to rotate, and the transmission bevel gear 42 rotates with the output pulley 43.

(2) The meshing of the transmission bevel gear 42 and the output bevel gear 44 drives the output bevel gear 44 to rotate. The semicircular gear 33 rotates with the output bevel gear 44. After the semicircular gear 33 rotates, it can mesh with the rack 40 and drive. The rack 40 moves forward, and the bottom cloth piece 37 moves with the rack 40. The surface of the yellow flower pear wood beads 32 is cleaned and polished, and the yellow flower pear wood beads 32 are rotated around the rope 31. The movement rod 36 moves with the bottom cloth piece 37 Through the meshing of the movement lever 36 with the sun gear 65, the sun gear 65 is driven to rotate, the sun gear 65 is engaged with the top lever 38, which drives the top lever 38 to move backward, and the top cloth sheet 39 moves backward with the top lever 38 and makes Huanghuali The surface of the wooden beads 32 is cleaned and sanded.

(3) After the semi-circular gear 33 is released from the rack 40, the bottom cloth piece 37 and the top cloth piece 39 are reset by the action of the bottom spring 66, thereby repeatedly cleaning and polishing the surface of the Huanghuali wood beads 32. The semi-circular gear 33 continues to engage with the rack 40, and can drive the bottom cloth sheet 37 and the top cloth sheet 39 to repeatedly clean and polish the surface of the Huanghuali wood beads 32.

(4) After the driving gear 25 is disengaged from the transmission gear 24, the cleaning and polishing of the yellow rosewood beads 32 between the top cloth sheet 39 and the bottom cloth sheet 37 are stopped.

(5) The driving gear 25 is turned to mesh with the output gear 52, which drives the output gear 52 to rotate. The tilting lever 54 rotates with the output gear 52, and the force spring 68 is compressed. The tilting lever 54 drives the movement block 57, the tilting plate 58 and the rotating lever. 45 rotates, the thrust block 29 moves along the right end of the bottom arc block 28 with the rotation rod 45 until it leaves the bottom arc block 28, the pressure spring 60 resets, pushes the thrust block 29 to the left, and the thrust block 29 pushes the clamping block 17. The clamping block 17 and the clamping plate 14 clamp the Huanghuali wooden beads 32, and the thrust block 29 drives the driving block 30 upward, thereby driving all the Huanghuali wooden beads 32 to move, so that the yellow cloth pear between the top cloth sheet 39 and the bottom cloth sheet 37 32 becomes Huanghuali Muzhu 32 on the left.

(6) The thrust block 29 continues to move and is pushed to the right by the top arc block 19, loosening the clamp block 17 and the transmission block 30, and the lateral spring 61 is reset to the right, so that the clamp block 17 and the clamp plate 14 loosen the Huanghuali wooden beads 32. The inclined plate 58 pushes the transmission rod 18 to rotate and move to the upper side of the transmission rod 18, the driving gear 25 is disengaged from the output gear 52, so that the force spring 68 is reset, thereby driving the inclined plate 58 to move along the right end wall of the arc surface block 49. After pushing the inclined block 46 to rotate, it moves to the lower side of the inclined block 46.

(7) Repeated cycles can complete the cleaning and polishing of the surface of all Huanghuali wooden beads 32.

The above embodiments are only for explaining the technical concept and characteristics of the present invention, and the purpose thereof is to enable those skilled in the art to understand and implement the content of the present invention, but not to limit the protection scope of the present invention. Any equivalent change or modification made according to the spirit and essence of the present invention should be covered by the protection scope of the present invention.

1. A yellow flower pear bracelet string maintenance equipment, including a bottom plate, which is characterized by:
A power mechanism is provided on the front surface of the bottom plate, and the power mechanism includes a motor installed on the front surface of the bottom plate, and the motor can drive the entire device as a power source;
a rope is provided on the front side of the bottom plate, and eighteen Huanghuali wooden beads are stringed on the rope. A maintenance mechanism is provided on the upper side of the power mechanism. The maintenance mechanism includes a top cloth sheet and a bottom cloth sheet that can be moved forward and backward. When the top cloth piece moves forward, the bottom cloth piece moves backward, thereby cleaning and polishing the yellow rosewood beads between the top cloth piece and the bottom cloth piece;
a replacement mechanism is provided on the left side of the power mechanism. The replacement mechanism includes a rotatable rotating rod. A pressure chamber with a downward opening is arranged in the lower end surface of the rotary rod. A thrust block is fixed at the lower end of the pressure spring, the compression spring is in a compressed state, a clamping block and a clamping plate are provided on the left side of the rotating rod, and a transmission block is fixed on the right end face of the clamping block, and the thrust block moves to At the clamp block, the pressure spring can be reset to push the clamp block to move to the left, so that the clamp plate and the clamp block clamp one of the Huanghuali wood beads, and the thrust block then pushes the driving block rises, thereby driving all the Huanghuali wooden beads together with the rope to rotate clockwise, so that the next Huanghuali wooden beads moves between the top cloth piece and the bottom cloth piece.

2. A maintenance device for a yellow flower pear bracelet string according to claim 1, wherein the power mechanism further comprises a driving shaft rotatably disposed on the front end surface of the motor, and a driving gear is fixed on the driving shaft. A transmission shaft is rotatably connected to the front surface of the bottom plate on the upper side of the motor. A transmission pulley and a transmission gear are fixed on the transmission shaft. The transmission gear meshes with the driving gear. The transmission shaft An output shaft is rotatably connected to the front surface of the bottom plate. A transmission bevel gear and an output pulley are fixed on the output shaft. The transmission bevel gear is located on the front side of the output pulley. The pulley and the transmission pulley are frictionally transmitted through a belt.

3. A maintenance device for a yellow flower pear bracelet string according to claim 1, wherein the maintenance mechanism further comprises a support block fixedly connected to the front end surface of the bottom plate, and a right end surface of the support block is rotatably provided A transverse shaft, a semicircular gear is fixed on the transverse shaft, an output bevel gear is fixed on the right end of the transverse shaft, the output bevel gear meshes with the transmission bevel gear, and a receiving cavity is provided in the bottom plate A central shaft is provided between the left and right end walls of the storage cavity, a central gear is fixed on the central shaft, and a top rod that can slide forward and backward is provided on the upper side of the central gear, and the top rod and the center gear Meshing, the front end of the top rod is located in the outer space, the top cloth piece is fixed on the lower end surface of the bottom arc block, and the bottom end of the top rod is fixedly provided with a bottom fixedly connected to the rear wall of the storage cavity A spring, a movement rod that can slide forward and backward is provided on the lower side of the center gear, the movement rod is engaged with the center gear, and the bottom cloth piece is fixedly disposed on the upper end surface of the movement rod. A rack is embedded in the lower end surface of the moving rod.

4. A maintenance device for a yellow flower pear bracelet string according to claim 1, wherein the replacement mechanism further comprises a torsion shaft rotationally connected to the front surface of the bottom plate, and the torsion shaft and the bottom plate There is a force spring between the output shaft and the tilting rod fixed on the torsion shaft. The tilting rod is located on the front side of the output gear. The lower side of the tilting rod is provided with a moving block and the upper end of the moving block. A telescopic groove with an opening facing upward is provided therein, and the inclined rod can slide in the telescopic groove. The lower end of the inclined rod is fixed with a telescopic spring whose lower end is fixedly connected to the lower end wall of the telescopic groove. An inclined plate is fixed on the end surface, the rotating rod is fixed on the lower end surface of the inclined plate, a first positioning rod is fixed on the front surface of the bottom plate, and the first positioning rod is provided with a first torsion spring for rotation. An inclined surface block, an arc surface block fixedly connected to the front surface of the bottom plate is provided on the upper side of the inclined surface block, and a second positioning rod fixedly connected to the front surface of the bottom plate is provided on the upper side of the curved surface block. Said through the second positioning rod A torsion spring is provided with a transmission rod. An upper side of the transmission rod is provided with a top arc block fixedly connected to the front surface of the bottom plate, and a lower portion of the transmission rod is provided with a bottom fixedly connected to the front surface of the bottom plate. Curved blocks.

5. A maintenance device for a yellow flower pear bracelet string according to claim 4, characterized in that: the front surface of the bottom plate is provided with a moving slot opening forward, and a lower end wall of the moving slot is fixed with a moving spring. The upper end of the moving spring is fixedly provided with a moving block slidingly connected to the moving groove, the front end of the moving block is fixedly provided with the clamping plate, a right end surface of the clamping plate is fixedly provided with a support plate, and an opening is provided in the support plate. A lateral groove facing right, a lateral spring is fixed at the left end wall of the lateral groove, a moving plate slidingly connected to the lateral groove is fixed at the right end of the transverse spring, and the clamping block is fixed at the right end of the moving plate.

6. The maintenance device for a yellow flower pear bracelet string according to claim 2, wherein the driving gear can be engaged with the output gear after the driving gear is rotated.

7. A maintenance device for a yellow flower pear bracelet string according to claim 1, wherein the pressure spring is in a compressed state.

8. A maintenance device for a yellow flower pear bracelet string according to claim 3, wherein the semicircular gear can be engaged with the rack after rotation.

9. A maintenance device for a yellow flower pear bracelet string according to claim 1, wherein a support rod is fixed on the front surface of the bottom plate, and the support rod is used to support the yellow flower pear wood beads.
